(19) United States
(12) Patent Application Publication
(10) Pub. No.: US 2024/0375973 A1
(43) Pub. Date: Nov. 14, 2024

(54) PROCESS FOR PRODUCING MAGNESIUM OXIDE

(71) Applicant: SETOLAS Holdings, Inc., Takamatsu-shi (JP)

(72) Inventors: Tetsuro Kameda, Takamatsu-shi (JP); Seiji Fujisawa, Takamatsu-shi (JP)

(73) Assignee: SETOLAS Holdings, Inc., Takamatsu-shi (JP)

(21) Appl. No.: 18/661,299

(22) Filed: May 10, 2024

(30) Foreign Application Priority Data
May 11, 2023 (JP) 2023-078593

(51) Int. Cl. C01F 5/06; B01D 9/00

(52) U.S. Cl. CPC C01F 5/06; B01D 9/0031; C01P 2004/03

(57) ABSTRACT

The present disclosure provides a novel process for production of magnesium oxide with more excellent manageability. The present disclosure is a process for producing magnesium oxide. The process of the present disclosure comprises the following carbonation step, separating step, crystallization step and calcination step.

The carbonation step is a step in which carbon dioxide gas is blown into a magnesium compound suspension to obtain a magnesium hydrogencarbonate aqueous solution.

The separating step is a step in which the magnesium hydrogencarbonate aqueous solution is treated for solid-liquid separation.

The crystallization step is a step in which magnesium carbonate is crystallized from the aqueous solution obtained in the separating step.

The calcination step is a step in which the magnesium carbonate is calcinated in order to obtain magnesium oxide.

In the present disclosure, the crystallization step is carried out under crystallization conditions with a crystallization temperature of 50° C. or higher and lower than 80° C. The crystallization step is also carried out under crystallization conditions such that the product of the crystallization temperature and the crystallization time is 60° C.·h or greater and less than 210° C.·h.

### FIELD

The present invention relates to a novel process for producing magnesium oxide.

### BACKGROUND

Magnesium oxide is used in a wide variety of industrial fields as an industrial starting material and as a pharmaceutical starting material. For example, magnesium oxide is known to exhibit excellent properties for various usages such as pharmaceuticals, foods, vulcanization accelerators, pigments, chemical heat storage materials, battery materials, ceramic materials, adsorbents polishing agents and catalysts.

Magnesium oxide is industrially produced by several different methods using seawater, irrigation or bittern as magnesium sources. One of these is the process for producing magnesium oxide described in PTL 1, for example, in which a magnesium oxide precursor is calcinated, the magnesium oxide precursor being a magnesium compound such as magnesium oxide, magnesium hydroxide or magnesium carbonate.

Incidentally, a process for producing magnesium carbonate is proposed in PTL 2, for example, as a process in which high-purity magnesium carbonate, particularly magnesium carbonate having a low iron content, is produced from a low-grade magnesium hydroxide ore source. In this magnesium carbonate production process, carbon dioxide gas and oxygen-containing gas are blown together into a suspension of low-grade magnesium hydroxide to form a solution containing magnesium hydrogencarbonate, and the liquid obtained from solid-liquid separation is heated to produce a magnesium carbonate precipitate. The production process of PTL 2 is considered to be a simple process for producing high purity magnesium carbonate.

PTL 3 proposes a method for removing impurities while producing magnesium carbonate by reaction between a magnesium hydroxide slurry and carbon dioxide gas. Specifically, in the impurity removal method that is proposed, the pH (which tends to fall during the course of carbonation) is kept at a pH of 7.6 to 8.0 at which the magnesium carbonate will not fully dissolve, and the undissolved magnesium generated upon completion of carbonation is used as a pre-coat agent for filtration of the carbonated reaction mixture.

The processes described in these patent documents are promising for producing high-purity magnesium oxide when used as steps within a process for producing magnesium oxide. High-purity magnesium oxide can be used as tablets for pharmaceuticals and food products, for example. PTL 4 discloses an example of tablets of this kind, composed mainly of magnesium oxide particles.

### CITATION LIST

### Patent Literature

[PTL 1] International Patent Publication No. WO2017/195686
[PTL 2] Japanese Unexamined Patent Publication No. 2010-132504
[PTL 3] Japanese Unexamined Patent Publication No. 63-40722
[PTL 4] International Patent Publication No. WO2011/030659

### SUMMARY

### Technical Problem

Such tablets are produced by molding a composition that contains magnesium oxide as the main component into a desired form by compression molding, or “tableting”. However, using the processes of PTLs 1 to 3 yields magnesium oxide with high bulk in some cases, often hampering its manageability when molding it into tablets.

If easily manageable magnesium oxide is desired, the magnesium oxides formed by the processes of PTLs 1 to 3 are inadequate and in need of further improvement.

It is an object of the present invention to provide a novel process for producing magnesium oxide with more excellent manageability.

### Solution to Problem

The present disclosure includes the following aspects.

### (First Disclosure)

The first disclosure is a process for producing magnesium oxide. The process for producing magnesium oxide according to the first disclosure comprises the following carbonation step, separating step, crystallization step and calcination step.

The carbonation step is a step in which carbon dioxide gas is blown into a magnesium compound suspension to obtain a magnesium hydrogencarbonate aqueous solution.

The separating step is a step in which the magnesium hydrogencarbonate aqueous solution is treated for solid-liquid separation.

The crystallization step is a step in which magnesium carbonate is crystallized from the aqueous solution obtained in the separating step.

The calcination step is a step in which the magnesium carbonate is calcinated in order to obtain magnesium oxide.

In the first disclosure, the crystallization step is carried out under crystallization conditions with a crystallization temperature of 50° C. or higher and lower than 80° C. The crystallization step is also carried out under crystallization conditions such that the product of the crystallization temperature and the crystallization time is 60° C.·h or greater and less than 210° C.·h.

### (Second Disclosure)

The second disclosure is the production process of the first disclosure wherein the crystallization temperature is 60° C. to 70° C.

### (Third Disclosure)

The third disclosure is the production process of the first disclosure or second disclosure wherein the product of the crystallization temperature and the crystallization time is 120° C.·h to 140° C.·h.

### (Fourth Disclosure)

The fourth disclosure is the production process according to any one of the first disclosure to third disclosure, wherein the crystallization step further includes a heating step in which the crystallized magnesium carbonate is heated.

### (Fifth Disclosure)

The fifth disclosure is the production process according to the fourth disclosure, wherein in the heating step, the magnesium carbonate is heated at a temperature of 50° C. to 250° C.

### (Sixth Disclosure)

The sixth disclosure is the production process according to the fourth disclosure or fifth disclosure, wherein in the heating step, the magnesium carbonate is heated for a heating time of 1 to 72 hours.

### (Seventh Disclosure)

The seventh disclosure is the production process according to any one of the fourth disclosure to sixth disclosure, wherein in the calcination step, the magnesium carbonate that has been heated in the heating step is calcinated at a temperature of 600° C. to 1500° C.

### Advantageous Effects of Invention

According to the production process of the invention it is possible to obtain magnesium oxide with more excellent manageability.

### BRIEF DESCRIPTION OF DRAWINGS

FIG. 1 shows scanning electron micrographs of magnesium carbonate as the intermediate product of Example 1 (a) and magnesium oxide as the final product after calcination (b), and magnesium carbonate as the intermediate product of Comparative Example 5 (c) and magnesium oxide as the final product after calcination (d). The white lines in the photographs indicate 1 μm length.

### DESCRIPTION OF EMBODIMENTS

Preferred embodiments of the process for producing magnesium oxide of the invention will now be described in detail. Unless otherwise specified, the numerical ranges used herein are ranges that include the upper and lower limits.

### [Process for Producing Magnesium Oxide]

The first embodiment of the invention is a process for producing magnesium oxide that comprises the following carbonation step, separating step, crystallization step and calcination step. In the carbonation step, carbon dioxide gas is blown into a magnesium compound suspension to obtain a magnesium hydrogencarbonate aqueous solution. In the separating step, the magnesium hydrogencarbonate aqueous solution is treated for solid-liquid separation. In the crystallization step, magnesium carbonate is crystallized from the aqueous solution obtained in the separating step. In the calcination step, the magnesium carbonate is calcinated in order to obtain magnesium oxide.

According to this embodiment, the crystallization step is carried out under crystallization conditions with a crystallization temperature of 50° C. or higher and lower than 80° C. The crystallization step is also carried out under crystallization conditions such that the product of the crystallization temperature and crystallization time is 60° C.·h or greater and less than 210° C.·h.

If the crystallization step is carried out under these specific crystallization conditions, the crystalline form of the crystallizing magnesium carbonate will tend to be needle crystals or plate crystals. This can lower the bulk of the magnesium carbonate and improve the manageability of the magnesium carbonate. Since the crystalline form of the magnesium carbonate is kept by the crystalline form of the magnesium oxide obtained after calcination, the crystalline form of the magnesium oxide after calcination also tends to be needle crystals or plate crystals. This lowers the bulk of the magnesium oxide after calcination and can improve the manageability of the magnesium oxide during molding.

Therefore, according to the production process of the embodiment, it is possible to obtain magnesium oxide with more excellent manageability.

If magnesium oxide with excellent manageability is obtained by the production process of the embodiment it becomes possible to improve productivity for products that will comprise the magnesium oxide, thus contributing to achievement of SDGs (Sustainable Development Goals) adopted by the United Nations summit.

The suspension of the magnesium compound to be used in the production process of the embodiment is not particularly restricted, and a suspension containing magnesium hydroxide, magnesium silicate, magnesium oxide, magnesium carbonate, or mixtures of two or more of the same, may be used.

For example, when a magnesium hydroxide suspension is to be used as the magnesium compound suspension, the magnesium hydroxide suspension can be obtained by a step of producing a magnesium hydroxide suspension in which seawater or a magnesium chloride aqueous solution is used as the starting material. Specifically, the production process of the embodiment may have a step of producing a magnesium hydroxide suspension before the carbonation step.

The step of producing the magnesium hydroxide suspension may be a method of mixing and reacting a magnesium source with an alkali source. Alternatively, the step of producing the magnesium hydroxide suspension may be a method of preparing magnesium hydroxide from an ore source as a suspension in water. When the former method is used as the step of producing the magnesium hydroxide suspension, the magnesium source used may be seawater or a magnesium chloride aqueous solution. The magnesium source used is preferably seawater.

The alkali source to be reacted with the magnesium source is not particularly restricted, and calcium hydroxide, for example, may be used. Hydrated lime is an example of calcium hydroxide. Hydrated lime can be obtained by digestion of calcined lime which is calcium oxide. The hydrated lime may also be in the form of milk of lime, for example.

The step described above is an example of the step of producing a magnesium hydroxide suspension, but if a suspension of a magnesium compound other than magnesium hydroxide is to be used, a different step suitable for the type of magnesium compound may be employed instead. When the magnesium compound suspension can be acquired without a production step, such a production step is not necessary.

The magnesium compound suspension obtained by the production step is then provided to the subsequent carbonation step.

Each step in the process for producing magnesium oxide of the embodiment will now be explained in detail.

### <Carbonation Step>

The carbonation step is a step in which carbon dioxide gas is blown into a magnesium compound suspension to obtain a magnesium hydrogencarbonate aqueous solution. The carbon dioxide gas used in the carbonation step may also include another gas, in a range that does not inhibit carbonation of the magnesium compound. When carbon dioxide gas is to be blown into the magnesium compound suspension, the carbon dioxide gas is preferably blown in while stirring the suspension.

The pH of the magnesium compound suspension is preferably adjusted during the carbonation step. The pH of the magnesium compound suspension may be adjusted depending on the types of impurities in the suspension and the types of impurities to be preferentially removed, so that the impurity components with relatively low ionization tendency precipitate out as solids. Examples of such impurities include Fe, Al, Si, As and Pb.

For example, the pH of the magnesium compound suspension is preferably adjusted to below 7.5 or below 7.4. Alternatively, the pH of the magnesium compound suspension is preferably adjusted to 7.0 or higher or 7.1 or higher. If the pH of the magnesium compound suspension is adjusted to within this range in the carbonation step it will be possible to dissolve magnesium hydrogencarbonate as the magnesium component while adequately precipitating out the suspension impurities as solids. A more high-purity magnesium oxide product can be obtained as a result. If the pH of the magnesium compound suspension is 7.5 or higher, a lower amount of magnesium component will dissolve, potentially making it impossible to obtain a satisfactory yield.

The impurities precipitated as solids by pH adjustment of the suspension can be removed by solid-liquid separation in the subsequent separating step. By adequately reducing impurities at the stage from the carbonation step to the separating step, the magnesium oxide obtained by the subsequent crystallization step and calcination step will have an extremely low impurity content, allowing higher purity magnesium oxide to be produced.

The pH of the magnesium compound suspension can be adjusted by blowing in carbon dioxide gas during the carbonation step. In this case the carbonation step preferably includes blowing in carbon dioxide gas while continuously or intermittently measuring the pH of the magnesium compound suspension.

There are no particular restrictions to the supply rate of carbon dioxide gas in the carbonation step for blowing in the carbon dioxide gas into the magnesium compound suspension. The carbon dioxide gas supply rate may be 5.0 L/min or lower, for example. The carbon dioxide gas supply rate may also be 0.1 L/min or higher, for example. A preferred upper limit for the carbon dioxide gas supply rate is 3.0 L/min or lower. A preferred lower limit for the carbon dioxide gas supply rate is 0.2 L/min or higher.

The concentration of the magnesium compound suspension in the carbonation step is not particularly restricted. The concentration of the magnesium compound suspension may be 30 g/L or lower, for example. The concentration of the magnesium compound suspension may also be l g/L or higher, for example. The concentration of the magnesium compound suspension is preferably 28 g/L or lower. The concentration of the magnesium compound suspension is also preferably 3 g/L or higher. The concentration of the magnesium compound suspension can be calculated by the following formula.

Suspension concentration (g/L)=Magnesium compound weight (g)/suspension volume (L)

The temperature of the suspension while blowing in carbon dioxide gas in the carbonation step is not particularly restricted, but preferably the carbon dioxide gas is blown in during the carbonation step with the magnesium compound suspension at a temperature of 0° C. to 50° C. If the suspension temperature is within this range, it will be possible to more reliably precipitate out multiple types of impurities in the suspension. A higher purity magnesium oxide product can be obtained as a result.

A more preferred upper limit temperature for the magnesium compound suspension in the carbonation step is 40° C. An even more preferred upper limit temperature for the magnesium compound suspension in the carbonation step is 30° C. A more preferred lower limit temperature for the magnesium compound suspension in the carbonation step is 20° C.

In the carbonation step, the magnesium hydrogencarbonate aqueous solution through which carbon dioxide gas has been blown preferably includes undissolved magnesium carbonate. If the magnesium hydrogencarbonate aqueous solution through which carbon dioxide gas has been blown includes undissolved magnesium carbonate, it will be easier to accomplish solid-liquid separation after the carbonation step. A higher purity magnesium oxide product can also be obtained as a result.

Air may also be blown in during the carbonation step after blowing carbon dioxide gas into the magnesium compound suspension. By first blowing carbon dioxide gas into the magnesium compound suspension, it is possible to dissolve the magnesium component while precipitating out Fe as an impurity. By then blowing air into the suspension, it is possible to precipitate out the still dissolved Fe as FeO. This will allow a higher purity magnesium oxide product to be obtained with even further reduced Fe impurity.

The impurities precipitated as solids in the carbonation step can be removed by solid-liquid separation in the subsequent separating step. The magnesium hydrogencarbonate aqueous solution obtained by the carbonation step is supplied to the separating step.

### <Separating Step>

The separating step is a step in which the magnesium hydrogencarbonate aqueous solution obtained by the carbonation step is treated for solid-liquid separation. More specifically, the separating step is a step of separating the magnesium hydrogencarbonate aqueous solution, as the liquid portion, from the impurities, as the solid portion. With this step it is possible to obtain a high-purity magnesium hydrogencarbonate aqueous solution with the impurities removed from the magnesium hydrogencarbonate aqueous solution.

The term “separation” as used herein includes the concept of complete separation between the solid portion and the liquid portion, as well as an unavoidable small amount of water in the solid portion.

There are no particular restrictions on the separating means used in the separating step, and for example, it may be filtration means, membrane separation means, centrifugal separation means, solid-liquid separation means or natural sedimentation means.

The separating step may directly use the magnesium hydrogencarbonate aqueous solution obtained from the carbonation step, but this is not limitative. For example, the concentration may be adjusted in the separating step by adding water to the magnesium hydrogencarbonate aqueous solution beforehand. The water used in this case may be ion-exchanged water, for example. The separating step may be carried out all at once, or as two or more steps.

The pH may be adjusted in the separating step depending on the types of impurities to be removed. The carbonation step and separating step may also be carried out as one set, repeating that set several times. In this case the pH of the suspension may be adjusted to be different for each set. Alternatively, the pH of the suspension may be adjusted to be the same for each set.

The magnesium hydrogencarbonate aqueous solution from which the impurities have been removed by the separating step is then supplied to the subsequent crystallization step.

### <Crystallization Step>

The crystallization step is a step in which magnesium carbonate is crystallized from the aqueous solution obtained in the separating step. In the crystallization step, the magnesium carbonate can be crystallized by heating the aqueous solution from the separating step at a predetermined temperature for a predetermined time. Throughout the present specification, the “heating temperature during crystallization of the magnesium carbonate” will be referred to as the “crystallization temperature”, to distinguish it from the heating temperature during the subsequent heating step. Similarly, the “heating time for crystallization of the magnesium carbonate” will be referred to as the “crystallization time”.

### (Crystallization Temperature)

The crystallization temperature during crystallization of the magnesium carbonate is 50° C. or higher and lower than 80° C., for this embodiment. The crystallization temperature is preferably 60° C. to 70° C. If the crystallization temperature is 80° C. or higher, the crystalline form of the magnesium carbonate that is obtained will be petal-shaped crystals and the bulk will tend to be higher.

The crystallization step for this embodiment is also carried out under crystallization conditions such that the product of the crystallization temperature and the crystallization time is 60° C.·h or greater and less than 210° C.·h. By carrying out the crystallization step under specific crystallization conditions in which the crystallization temperature is 50° C. or higher and lower than 80° C. and the product of the crystallization temperature and the crystallization time is 60° C.·h or greater and less than 210° C.·h, it is possible to obtain needle crystals or plate crystals of magnesium carbonate. If the crystalline form of the crystallizing magnesium carbonate is needle crystals or plate crystals, then the crystalline form of the magnesium oxide after calcination will also tend to be needle crystals or plate crystals. This will lower the bulk of the magnesium oxide, making it possible to obtain magnesium oxide with more excellent manageability. If the product of the crystallization temperature and the crystallization time is 210° C.·h or greater, the crystalline form of the magnesium carbonate that is obtained will be petal-shaped crystals and the bulk will tend to be higher.

The crystallization conditions are preferably such that the crystallization temperature is 60° C. to 70° C. and the product of the crystallization temperature and the crystallization time is 60° C.·h or greater and less than 210° C.·h. If the crystallization step is carried out under these crystallization conditions, it will be possible to more reliably crystallize magnesium carbonate as needle crystals or plate crystals.

The crystallization conditions are preferably such that the crystallization temperature is 50° C. or higher and lower than 80° C. and the product of the crystallization temperature and the crystallization time is 120° C.·h to 140° C.·h. If the crystallization step is carried out under these crystallization conditions it will be possible to even more reliably crystallize magnesium carbonate as needle crystals or plate crystals.

The crystallization conditions are especially preferably such that the crystallization temperature is 60° C. to 70° C. and the product of the crystallization temperature and the crystallization time is 120° C.·h to 140° C.·h. If the crystallization step is carried out under these crystallization conditions it will be possible to even more reliably crystallize magnesium carbonate as needle crystals or plate crystals.

### (Crystallization Time)

The crystallization time for crystallization of the magnesium carbonate for this embodiment is not particularly restricted so long as the product of the crystallization temperature and the crystallization time is 60° C.·h or greater and less than 210° C.·h. That is, the crystallization time may be a time in the range of 0.75 hour or longer and less than 4.2 hours. For the purpose of the present specification, the crystallization time is the time during which the crystallization temperature is maintained after the temperature of the aqueous solution after the separating step has been raised to reach the crystallization temperature.

### (Heating Step)

For this embodiment, the crystallization step may further include a heating step in which the crystallized magnesium carbonate is heated. Heating the crystallized magnesium carbonate will tend to result in a magnesium carbonate crystalline form of needle crystals or plate crystals. As a result, the bulk of the magnesium carbonate will tend to be lower, helping to more reliably improve manageability of the magnesium carbonate.

### (Heating Temperature)

The heating temperature of the magnesium carbonate in the heating step is not particularly restricted and may be a temperature of 50° C. to 250° C., for example. From the viewpoint of manageability of the magnesium carbonate, the preferred lower limit for the heating temperature is 60° C. From the viewpoint of manageability or productivity for the magnesium carbonate, the preferred upper limit for the heating temperature is 150° C.

### (Heating Time)

The heating time for the magnesium carbonate in the heating step is not particularly restricted and may be 1 to 72 hours, for example. From the viewpoint of manageability of the magnesium carbonate, the preferred lower limit for the heating time is 3 hours. From the viewpoint of manageability or productivity for the magnesium carbonate, the preferred upper limit for the heating time is 48 hours.

The magnesium carbonate crystallized in the crystallization step is obtained as the solid portion of the aqueous solution. Magnesium carbonate can therefore be obtained as a solid by solid-liquid separation of the aqueous solution containing the crystallized magnesium carbonate. Specifically, the crystallization step may further include a step in which the aqueous solution containing the crystallized magnesium carbonate is treated for solid-liquid separation and the magnesium carbonate is obtained as a solid.

The means for solid-liquid separation of the aqueous solution containing the crystallized magnesium carbonate is not particularly restricted, and the same separating means may be used as in the separating step, for example.

If necessary, a step of washing the crystallized magnesium carbonate may also be carried out during the crystallization step.

The magnesium carbonate obtained by the crystallization step is then supplied to the subsequent calcination step.

### <Calcination Step>

The calcination step is a step in which the magnesium carbonate obtained by the crystallization step is calcinated in order to obtain magnesium oxide.

The calcination means for calcination the magnesium carbonate is not particularly restricted so long as it can produce magnesium oxide. Such calcination means include a calcination furnace or microwaves, for example.

The calcination temperature for calcination of the magnesium carbonate is also not particularly restricted so long as it is a temperature that allows production of magnesium oxide. The calcination temperature may be a temperature of 600° C. or higher, for example. The upper limit for the calcination temperature is not particularly restricted, but it may be 1500° C., for example, from the viewpoint of quality and productivity of the magnesium oxide. The calcination temperature is preferably a temperature of 700° C. or higher. The calcination temperature is also preferably a temperature of 1200° C. or lower.

The calcination time for calcination of the magnesium carbonate is not particularly restricted so long as it allows production of magnesium oxide. The calcination time may be a time of 1 minute or longer. The upper limit for the calcination time is not particularly restricted but may be 24 hours, for example, from the viewpoint of productivity. The calcination time is preferably 30 minutes or longer. The calcination time is also preferably 6 hours or less.

The magnesium oxide obtained by the calcination step may be supplied to additional processing steps as necessary. Examples of such processing steps include a surface treatment step in which the particle surfaces of the magnesium oxide are treated with any of various surface treatment agents, a crushing step in which the magnesium oxide is crushed into powder, a sorting step in which the magnesium oxide is sorted into different particle sizes, and a molding step in which the magnesium oxide is molded into a predetermined form.

According to the production process of the embodiment it is possible to obtain magnesium oxide with more excellent manageability.

The production process of the invention is not restricted to the embodiments described above or the Examples described below, and can incorporate appropriate combinations, substitutions and modifications within a range that is not outside of the object and gist of the invention.

### EXAMPLES

The invention will now be explained in greater detail using Examples and Comparative Examples, with the understanding that the invention is not limited only to the Examples.

### Example 1

A 15 g/L magnesium hydroxide suspension was placed in a reaction tank. The magnesium hydroxide suspension was blown in carbon dioxide gas at a rate of 500 mL/min until the pH of the suspension reached a predetermined value while stirring, to obtain a magnesium hydrogencarbonate aqueous solution.

The obtained magnesium hydrogencarbonate aqueous solution was passed through a Nutsche filter for solid-liquid separation to remove the solid impurities. The solution was then heated to 70° C. and the temperature was maintained for 1 hour to precipitate magnesium carbonate. The solution was subsequently filtered to obtain solid magnesium carbonate. The obtained solid was heated at 105° C. for 24 hours to obtain basic magnesium carbonate powder.

A calcination crucible was prepared, and the basic magnesium carbonate was placed in it. The crucible was loaded into a calcination furnace preheated and kept at 900° C. After loading, it was calcinated for 2 hours at 900° C. under atmospheric pressure to obtain calcinated product of magnesium oxide. The calcinated product was screened with a 150 micrometer-mesh filter to obtain magnesium oxide powder for Example 1.

### Example 2

Magnesium oxide powder for Example 2 was obtained in the same manner as Example 1, except that the crystallization time was changed to 2 hours.

### Example 3

Magnesium oxide powder for Example 3 was obtained in the same manner as Example 1, except that the crystallization temperature was changed to 60° C.

### Example 4

Magnesium oxide powder for Example 4 was obtained in the same manner as Example 1, except that the crystallization temperature and crystallization time were changed to 60° C. and 2 hours, respectively.

### Example 5

Magnesium oxide powder for Example 5 was obtained in the same manner as Example 1, except that the crystallization temperature and crystallization time were changed to 60° C. and 3 hours, respectively.

### Example 6

Magnesium oxide powder for Example 6 was obtained in the same manner as Example 1, except that the calcination temperature was changed to 800° C.

### Comparative Example 1

Magnesium oxide powder for Comparative Example 1 was obtained in the same manner as Example 1, except that the crystallization time was changed to 3 hours.

### Comparative Example 2

Magnesium oxide powder for Comparative Example 2 was obtained in the same manner as Example 1, except that the crystallization temperature was changed to 80° C.

### Comparative Example 3

Magnesium oxide powder for Comparative Example 3 was obtained in the same manner as Example 1, except that the crystallization temperature and crystallization time were changed to 90° C. and 0.5 hour, respectively.

### Comparative Example 4

Magnesium oxide powder for Comparative Example 4 was obtained in the same manner as Example 1, except that the crystallization temperature was changed to 90° C.

### Comparative Example 5

Magnesium oxide powder for Comparative Example 5 was obtained in the same manner as Example 1, except that the crystallization temperature and crystallization time were changed to 95° C. and 3 hours, respectively.

### Comparative Example 6

Magnesium oxide powder for Comparative Example 6 was obtained in the same manner as Example 1, except that the crystallization temperature and crystallization time were changed to 95° C. and 6 hours, respectively.

The bulk (mL/10 g) of each of the magnesium carbonates as intermediate products in Examples 1 to 6 and Comparative Examples 1 to 6 and the magnesium oxides obtained as final products, obtained as described above, were measured by the following measuring method. The measurement results are shown below in Table 1.

### (Bulk Measuring Method)

A sample of the magnesium carbonate or magnesium oxide to be measured was weighed out to 5 g and placed in a 100 mL graduated cylinder, and the sample volume (mL) was measured. The volume (mL) per 5 g of sample was converted to volume (mL) per 10 g, and recorded as the bulk (mL/10 g).

TABLE 1

| | | Example | Example | Example | Example | Example | Example |
|---|---|---|---|---|---|---|---|
| | | 1 | 2 | 3 | 4 | 5 | 6 |
| Crystallization | Crystallization | 70 | 70 | 60 | 60 | 60 | 70 |
| conditions | temperature | | | | | | |
| | (° C.) | | | | | | |
| | Crystallization | 1 | 2 | 1 | 2 | 3 | 1 |
| | time (h) | | | | | | |
| | Product of | 70 | 140 | 60 | 120 | 180 | 70 |
| | temperature · | | | | | | |
| | time | | | | | | |
| | (° C. · h) | | | | | | |
| (After | Bulk (mL/10 g) | 55 | 86 | 58 | 55 | 52 | 55 |
| crystallization) | | | | | | | |
| Magnesium | | | | | | | |
| carbonate | | | | | | | |
| Calcination | Calcination | 900 | 900 | 900 | 900 | 900 | 800 |
| conditions | temperature | | | | | | |
| | (° C.) | | | | | | |
| | Calcination | 2 | 2 | 2 | 2 | 2 | 2 |
| | time | | | | | | |
| | (h) | | | | | | |
| (After | Bulk (mL/10 g) | 51 | 82 | — | 51 | 45 | 49 |
| calcination) | | | | | | | |
| Magnesium | | | | | | | |
| oxide | | | | | | | |

| | | Comp. | Comp. | Comp. | Comp. | Comp. | Comp. |
|---|---|---|---|---|---|---|---|
| | | Ex. 1 | Ex. 2 | Ex. 3 | Ex. 4 | Ex. 5 | Ex. 6 |
| Crystallization | Crystallization | 70 | 80 | 90 | 90 | 95 | 95 |
| conditions | temperature | | | | | | |
| | (° C.) | | | | | | |
| | Crystallization | 3 | 1 | 0.5 | 1 | 3 | 6 |
| | time (h) | | | | | | |
| | Product of | 210 | 80 | 45 | 90 | 285 | 570 |
| | temperature · | | | | | | |
| | time | | | | | | |
| | (° C. · h) | | | | | | |
| (After | Bulk (mL/10 g) | 158 | 170 | 175 | 119 | 91 | 78 |
| crystallization) | | | | | | | |
| Magnesium | | | | | | | |
| carbonate | | | | | | | |
| Calcination | Calcination | 900 | 900 | 900 | 900 | 900 | 900 |
| conditions | temperature | | | | | | |
| | (° C.) | | | | | | |
| | Calcination | 2 | 2 | 2 | 2 | 2 | 2 |
| | time | | | | | | |
| | (h) | | | | | | |
| (After | Bulk (mL/10 g) | 195 | 200 | — | 133 | 101 | 105 |
| calcination) | | | | | | | |
| Magnesium | | | | | | | |
| oxide | | | | | | | |

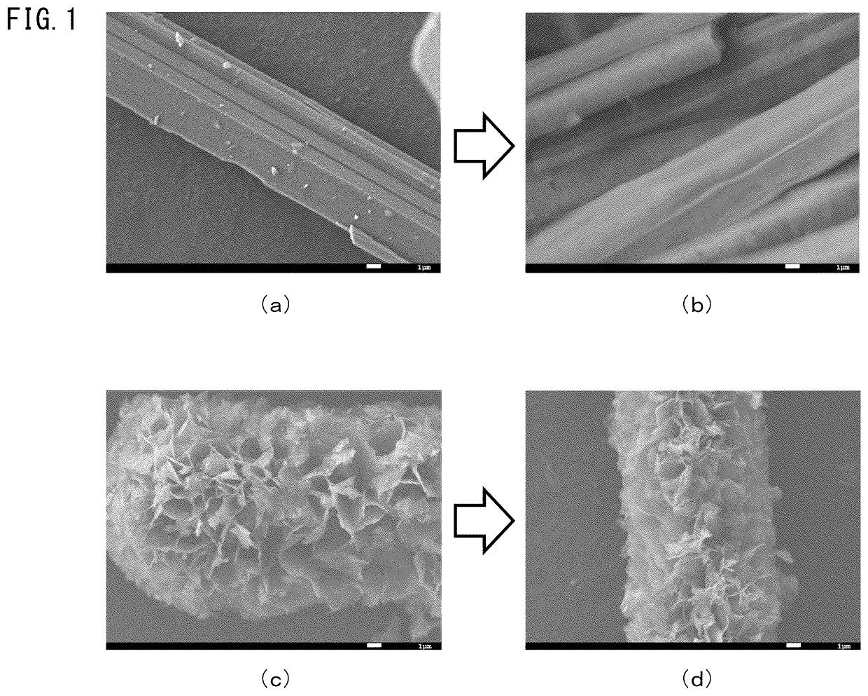

The magnesium carbonate as the intermediate product of Example 1 and the magnesium oxide as the final product obtained after calcination were observed with a scanning electron microscope, and the crystalline forms of each were confirmed. Similarly, the magnesium carbonate as the intermediate product of Comparative Example 5 and the magnesium oxide as the final product obtained after calcination were observed with a scanning electron microscope, and the crystalline forms of each were confirmed. The scanning electron micrographs are shown in FIG. 1.

### (Tableting Test)

A HAND-TAB manual tabletop tablet molding machine (HANDTAB-100R by Ichihashi Seiki Co., Ltd.) was used for tableting of the magnesium oxides of Examples 1 to 6 (250 mg, φ10 flat pestle) under a pressure of 10 kN, for molding of tablets. The obtained tablets were evaluated for thickness (mm) and hardness (N). The hardness of each tablet was measured using a load cell-type tabletop hardness meter (DC-50 by Okada Seiko Co., Ltd.). The measured values for the tablet hardnesses were the averages for 3 measurements. The tablet evaluation results are shown in Table 2 below.

TABLE 2

| | | Example 1 | Example 2 | Example 3 | Example 4 | Example 5 | Example 6 |
|---|---|---|---|---|---|---|---|
| Tablet | Thickness | 2.04 | 2.04 | 1.79 | 1.88 | 1.84 | 2.11 |
| evaluation | (mm) | | | | | | |
| | Hardness | 13 | 58 | 5 | 13 | 13 | 29 |
| | (N) | | | | | | |

As shown in Table 1, the magnesium oxides of Examples 1 to 6 produced by the production process of the invention all had low bulk, indicating that the process can improve manageability during molding. The magnesium carbonates as intermediate products of Examples 1 to 6 also had low bulk, indicating excellent manageability.

However, the magnesium oxides of Comparative Examples 1 to 6 produced by production processes with different crystallization conditions all had high bulk, indicating poor manageability for molding. The magnesium carbonates as intermediate products of Comparative Examples 1 to 6 also had high bulk, indicating poor manageability.

Moreover, as shown in FIG. 1, the magnesium carbonate as the intermediate product of Example 1 and the magnesium oxide as the final product after calcination both had needle crystal forms. However, the magnesium carbonate as the intermediate product of Comparative Example 5 and the magnesium oxide as the final product after calcination both had highly bulky petal-shaped crystal forms. It is believed that the differences in bulk between the Examples and the Comparative Examples are attributed to their difference in crystalline form.

As shown in Table 2, the magnesium oxides of Examples 1 to 6 also had excellent tableting properties.

### INDUSTRIAL APPLICABILITY

The process for producing magnesium oxide according to the invention can be suitably used for production of magnesium oxide that can be used for various purposes such as pharmaceuticals, foods, vulcanization accelerators, pigments, chemical heat storage materials, battery materials, ceramic materials, adsorbents polishing agents and catalysts, for example.

1. A process for producing magnesium oxide that comprises:
a carbonation step in which carbon dioxide gas is blown into a magnesium compound suspension to obtain a magnesium hydrogencarbonate aqueous solution,
a separating step in which the magnesium hydrogencarbonate aqueous solution is treated for solid-liquid separation,
a crystallization step in which magnesium carbonate is crystallized from an aqueous solution obtained in the separating step, and
a calcination step in which the magnesium carbonate is calcinated to obtain magnesium oxide,
wherein the crystallization step is carried out under crystallization conditions such that a crystallization temperature is 50° C. or higher and lower than 80° C., and a product of the crystallization temperature and a crystallization time is 60° C.·h or greater and less than 210° C.·h.

2. The process according to claim 1, wherein the crystallization temperature is 60° C. to 70° C.

3. The process according to claim 1, wherein the product of the crystallization temperature and the crystallization time is 120° C.·h to 140° C.·h.

4. The process according to claim 1, wherein the crystallization step further includes a heating step in which a crystallized magnesium carbonate is heated.

5. The process according to claim 4, wherein in the heating step, the magnesium carbonate is heated at a temperature of 50° C. to 250° C.

6. The process according to claim 4, wherein in the heating step, the magnesium carbonate is heated for a heating time of 1 to 72 hours.

7. The process according to claim 5, wherein in the calcination step, the magnesium carbonate that has been heated in the heating step is calcinated at a temperature of 600° C. to 1500° C.
